(19) United States
(12) Patent Application Publication
(10) Pub. No.: US 2020/0140784 A1
(43) Pub. Date: May 7, 2020

(54) LOW PH DETERGENT COMPOSITION

(71) Applicant: The Procter & Gamble Company, Cincinnati, OH (US)

(72) Inventors: Sarah Ann Delaney, Hebron, KY (US); Kevin Michael Chaney, West Chester, OH (US)

(21) Appl. No.: 16/676,484

(22) Filed: Nov. 7, 2019

Related U.S. Application Data
(60) Provisional application No. 62/756,855, filed on Nov. 7, 2018.

(51) Int. Cl. C11D 3/20; C11D 11/00; C11D 1/83; C11D 3/50; C11D 3/43

(52) U.S. Cl. CPC C11D 3/2086; C11D 11/0017; C11D 1/83; C11D 1/22; C11D 3/2044; C11D 3/50; C11D 3/43; C11D 3/2079

(57) ABSTRACT

Detergent compositions and more specifically, to low pH detergent compositions comprising natural feedstock components. Methods of making and using the same.

### FIELD OF THE INVENTION

The present disclosure relates to detergent compositions and, more specifically, to low pH detergent compositions comprising renewable components and exhibit good performance, as compared to both traditional detergent formulations that contain non-renewable ingredients.

### BACKGROUND OF THE INVENTION

Traditionally, detergent compositions have been formulated to a composition pH of greater than about 7. A basic pH helps to ensure that the surfactant systems, enzymes, or other organic solvents remain solubilized in the wash water. These modern detergents often comprise a blend of synthetic surfactants that are petroleum-derived, along with any number of additional ingredients, such as builders, water-conditioners, dispersants, soil-release polymers, detersive enzymes, and bleaching agents, to improve cleaning performance and to achieve compositions that are consumer acceptable.

However, the evolving consumer desires a product which has minimal number of ingredients, is based on natural feedstock materials, and one that performs as good or better than her current natural detergent on laundry stains and whiteness.

Surprisingly, it has been found that certain acidic detergents (i.e., with pH less than about 7) may provide benefits, such as improved removal of residues from fabrics and associated improvement in whiteness, improved bleachable stain removal, and self-preservation benefits while allowing one to formulate using materials that are natural.

As such, there is a need for a laundry detergent that is both low pH and has an increased concentration of renewable components.

### SUMMARY OF THE INVENTION

An acidic laundry detergent composition is disclosed. The acidic laundry composition comprises from about 2% to 20% by weight of the detergent of a surfactant system and greater than 10% of an organic acid. The composition comprises of greater than 34% of biobased content.

Further disclosed is an acidic laundry detergent composition comprising from about 2% to 20% by weight of the detergent of a surfactant system and greater than 10% of an organic acid. The composition comprises of at least 50% of biobased content.

### DETAILED DESCRIPTION OF THE INVENTION

In this description, all concentrations and ratios are on a weight basis of the detergent composition unless otherwise specified. Elemental compositions such as percentage nitrogen (% N) are percentages by weight.

Molecular weights of polymers are number average molecular weights unless otherwise specifically indicated.

As used herein, the articles “a” and “an” when used in a claim, are understood to mean one or more of what is claimed or described.

As used herein, the terms “include,” “includes,” and “including” are meant to be non-limiting.

The term “renewable” is synonomous with the terms “biobased,” “sustainable,” “sustainably derived,” or “from sustainable sources” and means bio-derived (derived from a renewable resource, e.g., plants) or “non-geologically derived.” “Geologically derived” means derived from, for example, petrochemicals, natural gas, or coal. “Geologically derived” materials cannot be easily replenished or regrown (e.g., in contrast to plant- or algae-produced oils).

As used herein, the term “renewable component” refers to a component that is derived from renewable feedstock and contains renewable carbon. A renewable feedstock is a feedstock that is derived from a renewable resource, e.g., plants, and non-geologically derived. A material may be partially renewable (less than 100% renewable carbon content, from about 1% to about 50% renewable carbon content) or 100% renewable (100% renewable carbon content). A renewable material may be blended with a nonrenewable material.

“Renewable carbon” may be assessed according to the “Assessment of the Biobased Content of Materials” method, ASTM D6866.

As used herein, the term “natural oils” means oils that are derived from plant or algae matter (also referred to as renewable oils). Natural oils are not based on kerosene or other fossil fuels. The term “oils” include fats, fatty acids, waste fats, oils, or mixtures thereof. Natural oils include, but are not limited to, coconut oil, babassu oil, castor oil, algae byproduct, beef tallow oil, borage oil, camelina oil, Canola® oil, choice white grease, coffee oil, corn oil, Cuphea Viscosissima oil, evening primrose oil, fish oil, hemp oil, hepar oil, jatropha oil, Lesquerella Fendleri oil, linseed oil, Moringa Oleifera oil, mustard oil, neem oil, palm oil, perilla seed oil, poultry fat, rice bran oil, soybean oil, stillingia oil, sunflower oil, tung oil, yellow grease, cooking oil, and other vegetable, nut, or seed oils. A natural oil typically includes triglycerides, free fatty acids, or a combination of triglycerides and free fatty acids, and other trace compounds.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

The compositions of the present invention can comprise, consist essentially of, or consist of, the components of the present disclosure.

Unless otherwise noted, all component or composition levels are in reference to the active portion of that component or composition, and are exclusive of impurities, for example, residual solvents or by-products, which may be present in commercially available sources of such components or compositions.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Detergent Composition

As used herein the phrase “detergent composition” includes compositions and formulations designed for cleaning soiled material. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation. The cleaning compositions may have a form selected from liquid, single-phase or multi-phase unit dose, pouch, gel, or paste. When the compositions are in a unit dose form, the composition may be encapsulated in a water-soluble film or pouch; the water-soluble film or pouch may comprise polyvinyl alcohol, polyvinyl acetate, or mixtures thereof. The unit dose form may comprise at least two compartments, or at least three compartments. At least one compartment may be superimposed on another compartment.

In some aspects, the compositions comprise from about 50% to about 95%, or from about 60% to about 90%, or from about 65% to about 81%, by weight of the composition, water. In some aspects, the compositions comprise at least about 50%, or at least about 60%, or at least about 70%, or at least about 75%, or at least about 80%, or at least about 85% water. When the composition is in concentrated or unit dose form, the composition may comprise less than about 50% water, or less than about 30% water, or less than about 20% water, or less than about 10% water, or less than about 5% water.

The detergent compositions disclosed herein may contain from about 1% by weight of renewable components (biobased), or from about 5% by weight of renewable components, or from about 10% to about 100% by weight of renewable components, such as: from about 20% to about 100%, or from about 30% to about 100%, of from about 40% to about 100%, or from about 34% to about 100%, or from about 40% to about 100%, or from about 50% to about 100%, or from about 60% to about 100%, or from about 70% to about 100%, or from about 80% to about 100%, or from about 90% to about 100%, by weight of renewable components.

The compositions may have at least 50% transmittance of light using a 1 centimeter cuvette, at a wavelength of 410-800 nanometers, or 570-690 nanometers, where the composition is substantially free of dyes. The composition may have greater than 50% transmittance, at least 70% transmittance, or at least 80% transmittance of light using a 1 centimeter curvette, at a wavelength of 410-800 nanometers, or 570-690 nanometers, where the composition is substantially free of dyes.

Alternatively, transparency of the composition may be measured as having an absorbency in the visible light wavelength (about 410 to 800 nm) of less than 0.3, which is in turn equivalent to at least 50% transmittance using cuvette and wavelength noted above. For purposes of the disclosure, as long as one wavelength in the visible light range has greater than 50% transmittance, it is considered to be transparent/translucent.

In some aspects, the compositions are present in a single phase. In some aspects, the disclosed compositions are isotropic at 22° C. As used herein, “isotropic” means a clear mixture, having a % transmittance of greater than 50% at a wavelength of 570 nm measured via a standard 10 mm pathlength cuvette with a Beckman DU spectrophotometer, in the absence of dyes and/or opacifiers.

The laundry detergent composition(s) may comprise surfactants derived from renewable fatty alcohol. The composition is substantially free of dye and brightener. The laundry detergent composition(s) may be a liquid.

Surfactant

The detergent compositions described herein comprise from about 2% to about 20%, or from about 9% to about 20%, or from about 5% to about 15%, or from about 7% to about 12% by weight of the detergent composition of a surfactant system.

The surfactant system may comprise a detersive surfactant selected from nonionic surfactants, anionic surfactants, amphoteric surfactants, zwitterionic surfactants, cationic surfactants, or mixtures thereof.

Nonionic Surfactant

The surfactant system of the present compositions comprises a nonionic surfactant. In some aspects, the surfactant system comprises no more than two nonionic surfactants.

In some aspects, the detergent composition comprises from about 0.1% to about 20%, or from about 2% to about 15%, or from about 5% to about 12%, by weight of the detergent composition, of nonionic surfactant.

Suitable nonionic surfactants useful herein include any of the conventional nonionic surfactants typically used in detergent products. These include, for example, alkoxylated fatty alcohols and amine oxide surfactants. Generally, the nonionic surfactants used herein are liquids. Preferably, the nonionic surfactant is sourced from a natural feedstock such as coconut oil or palm seed oil. The nonionic surfactant may be sourced from a seed oil. The seed oil is at least one of castor oil, soybean oil, olive oil, palm oil, palm kernel oil, peanut oil, rapeseed oil, corn oil, sesame seed oil, cottonseed oil, canola oil, safflower oil, linseed oil, coconut oil, or sunflower oil, or blends thereof. The seed oil may be either hydrogenated or partially hydrogenated.

The nonionic may be a carbohydrate based sugar surfactant selected from the group consisting of alkyl polyglycosides, polyhydroxy fatty acid amides (“glucamides”) and mixtures thereof. The nonionic may be alkenyl glycasuccinimide.

The nonionic surfactant may be an ethoxylated nonionic surfactant. These materials are described in U.S. Pat. No. 4,285,841, Barrat et al, issued Aug. 25, 1981. In one aspect, the nonionic surfactant is selected from the ethoxylated alcohols and ethoxylated alkyl phenols of the formula R(OC₂H₄)ₙ OH, where R is selected from the group consisting of aliphatic hydrocarbon radicals containing from about 8 to about 18 carbon atoms and alkyl phenyl radicals in which the alkyl groups contain from about 8 to about 12 carbon atoms, and the average value of n is from about 5 to about 15. These surfactants are more fully described in U.S. Pat. No. 4,284,532, Leikhim et al, issued Aug. 18, 1981. In one aspect, the nonionic surfactant is selected from ethoxylated alcohols (also known as fatty alcohol ethoxylates) having an average of from about 10 to about 16 carbon atoms in the alcohol and an average degree of ethoxylation of from about 1 to about 12 moles of ethylene oxide per mole of alcohol.

In some aspects, the nonionic surfactant comprises C12-C18 alkyl ethoxylate. In some aspects, the C12-C18 alkyl ethoxylate is selected from the group consisting of: C12,14 EO9; C12,14 EO7; and mixtures thereof.

Another suitable type of nonionic surfactant useful herein is amine oxide. Amine oxides are materials which are often referred to in the art as “semi-polar” nonionics. Amine oxides may have the formula: R(EO)ₓ(PO)_{y}(BO)_{z}N(O)(CH₂R′)₂.qH₂O. In this formula, R is a relatively long-chain hydrocarbyl moiety which can be saturated or unsaturated, linear or branched, and can contain from 8 to 20, in one embodiment from 10 to 16 carbon atoms, and is alternatively a C₁₂-C₁₆ primary alkyl. R is a short-chain moiety, and may be selected from hydrogen, methyl and —CH₂OH. When x+y+z is different from 0, EO is ethyleneoxy, PO is propyleneneoxy and BO is butyleneoxy. Amine oxide surfactants are non-limitingly illustrated by C₁₂₋₁₄ alkyldimethyl amine oxide. In some aspects, the surfactant system is substantially free of semi-polar nonionic surfactants, or of amine oxides.

The nonionic surfactant may be a renewable surfactant. Suitable nonionic surfactants include C₈-C₁₈ alkyl ethoxylates, such as, C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic from BASF; C₁₄-C₂₂ mid-chain branched alcohols, BA; C₁₄-C₂₂ mid-chain branched alkyl alkoxylates, BAEₓ, wherein x is from 1 to 30; and ether capped poly(oxyalkylated) alcohol surfactants.

Suitable renewable nonionic detersive surfactants include alkylpolysaccharides, such as alkylpolyglycosides, and methyl ester ethoxylates.

A typical nonionic alcohol ethoxylate surfactant has the following formula:

H₃C—(CH₂)ₘ—(O—CH₂—CH₂)ₙ—OH

The (H₃C—(CH₂)ₘ) portion of the formula is the hydrophobic portion, and the ((O—CH₂—CH₂)ₙ—OH) portion is the hydrophilic portion. The molar mass of the hydrophobic CH₃—(CH₂)ₘ portion (Mp) is calculated using the equation 15+(m)*14 where m=average chain length-1. The molar mass of the hydrophilic portion (Mh) can be calculated by n*44+17, where n is the number of ethoxylate groups (EO).

Table 1 below shows a non-limiting list of exemplary nonionic surfactants and their corresponding HLB values. The HLB value is calculated using the equation referenced above. Commercially available nonionic surfactants typically consist of a distribution of alcohol chain lengths. In order to estimate the molar mass, an average chain length is used, unless otherwise specified in the material specifications.

TABLE 1
Exemplary nonionic surfactants and HLB values

| | Average | | | | | |
|---|---|---|---|---|---|---|
| | Chain | | Hydrophobic | Hydrophilic | | |
| | Length | # EO | portion | portion | Total | |
| Surfactants | (m) | (n) | (Mp) | (Mh) | (M) | HLB |
| C16 EO7 | 16 | 7 | 225 | 325 | 550 | 11.82 |
| C12,14 EO7 | 13 | 7 | 183 | 325 | 508 | 12.80 |
| C12,14 EO9 | 13 | 9 | 183 | 413 | 596 | 13.86 |

A sample calculation for C12, 13 EO 3 (HLB=9.17), an alcohol ethoxylate comprising a hydrophobic portion with an average 12 to 13 carbons (average=12.5), and a hydrophilic portion with three ethoxylate groups, is shown below:

(Mp)=15+(12.5-1)*14=176

(Mh)=3*44+17=149

(M)=Mp+Mh=176+149=325

HLB=20*149/325=9.17

The alkoxylated fatty alcohol materials useful in the detergent compositions herein typically have HLB values that range from about 10 or greater such as 10 to about to about 17, or from about 11 to about 15, or from about 12 to about 15. In some aspects, the nonionic surfactant is a fatty alcohol ethoxylate selected from the group consisting of: C11,16 EO7; C12,14 EO7; C12,14 EO8; C12,14 EO9; C12,14 EO9; C14,18 EO9; C12 EO9; and mixtures thereof.

Anionic Surfactant

The surfactant system may comprise anionic surfactant. The anionic surfactant may be a renewable surfactant. In some aspects, the composition comprises, by weight of the detergent composition, from about 1% to about 25%, or from about 2% to about 20%, or from about 5% to about 15%, of anionic surfactant.

Suitable anionic surfactants include any conventional anionic surfactant used in detergent products. These include, for example, the alkyl benzene sulfonic acids and their salts, alkoxylated or non-alkoxylated alkyl sulfate materials, or specific surfactants such as, for example, sodium lauryl sulfate (SLS). The anionic surfactants may be present in acid form or in neutralized (e.g., salt) form. The anionic surfactants may be linear, branched, or a mixture thereof.

Exemplary anionic surfactants are the alkali metal salts of Cm-Cis alkyl benzene sulfonic acids or C₁₁-C₁₄ alkyl benzene sulfonic acids. In some aspects, the alkyl group is linear, and such linear alkyl benzene sulfonates are known as “LAS.” Alkyl benzene sulfonates, and particularly LAS, are well known in the art. Such surfactants and their preparation are described in, for example, U.S. Pat. Nos. 2,220,099 and 2,477,383. Especially useful are the sodium and potassium linear straight chain alkylbenzene sulfonates in which the average number of carbon atoms in the alkyl group is from about 11 to about 14. Sodium C₁₁-C₁₄, e.g., C₁₂, LAS is a specific example of such surfactants.

The composition may further comprise other anionic surfacatants such as, for example, ethoxylated alkyl sulfate surfactants, Natural based anionic surfactants: APG, GS base, glucotain Clean™ from Clariant, D-glucitol, 1-deoxy-(methlamino)-N—C12-14-acyl deriv, or combinations thereof.

The surfactant system may comprise a mixture of anionic surfactant and nonionic surfactant, e.g., linear alkyl benzene sulfonic acid and C12-18 alkyl ethoxylate. In some aspects, the weight ratio of anionic surfactant to nonionic surfactant is from about 0.1:100 to about 100:0.1, or from about 1:100 to about 100:1, or from about 1:100 to about 90:100, or from about 40:100 to about 75:100.

Organic Acid

The detergent comprises one or more organic acids selected from the group consisting of acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof. Preferably, the detergent composition may comprise an organic acid selected from the group consisting of acetic acid, lactic acid, and citric acid.

The detergent compositions of the present invention may comprise one or more additional organic acids. The additional organic acid may be in the form of an organic carboxylic acid or polycarboxylic acid. Examples of organic acids that may be used include: acetic acid, adipic acid, aspartic acid, carboxymethyloxymalonic acid, carboxymethyloxysuccinic acid, citric acid, formic acid, glutaric acid, hydroxyethyliminodiacetic acid, iminodiacetic acid, lactic acid, maleic acid, malic acid, malonic acid, oxydiacetic acid, oxydisuccinic acid, succinic acid, sulfamic acid, tartaric acid, tartaric-disuccinic acid, tartaric-monosuccinic acid, or mixtures thereof. In some aspects, the composition comprises organic acids that can also serve as detergent builders, such as citric acid.

The organic acid may be a water-soluble or water-miscible acid. In some aspects, the organic acid has a solubility in water at 20° C. of at least about 10 g acid/100 ml water, or at least about 30 g acid/100 ml water, or at least about 50 g acid/100 ml water, or at least about 70 g acid/100 ml water, or at least about 85 g/100 ml water. In some aspects, the composition is substantially free of fatty acid.

The organic acid may be a low-weight acid, for example, an acid having a molecular weight of less than 210 g/mole. In some aspects, the organic acid has no more than nine carbon atoms, alternatively no more than six carbon atoms. The organic acid in the detergent composition may have no more than four carbon atoms, or no more than three carbon atoms, or fewer than three carbon atoms. Specific examples of organic acids having fewer than three carbon atoms include formic acid and acetic acid.

The compositions may comprise from about 6% to about 30%, or from about 8% to about 25%, or from about 10% to about 15%, or from about 12% to about 17%, by weight of the composition, of the organic acid, such as, for example, 13%, 14%, 15%, 16%, 17%, 18%, 19%, 20%, 21%, 22%, 23%, 24%. The compositions may comprise greater than 10% by weight of the composition, of the organic acid, such as, for example, greater than 15%, greater than 20%, or greater than 25%. The composition may comprise a ratio of surfactant system to organic acid of less than or equal to about 3, such as, for example, between 0.1 and 3, such as, for example, 0.5, 1, 1.5, 2 or 2.5.

The compositions may comprise a preservative. Suitable preservatives may be selected by one of ordinary skill in the art and may include Proxel™ (available from Arch Chemicals/Lonza). The composition may comprise from about 0.01% to about 2.0%, or about 0.1% to about 1.0%, or about 0.1% to about 0.3%, by weight of the composition, of preservative. In some aspects, the compositions comprise less than 0.01% of a preservative. In some aspects, the compositions are substantially free of preservatives or, preferably, preservative free.

In some aspects, an alkalizing agent is added to the composition in order to obtain the desirable neat pH of the composition. Suitable alkalizing agents include hydroxides of alkali metals or alkali earth metals, such as sodium hydroxide, or alkanolamines, such as methanolamine (MEA) or triethanolamine (TEA) or mixtures thereof. In some aspects, the composition from about 0.25%, or from about 0.3%, or from about 0.35%, or from about 0.4% to about 10%, or to about 5% or to about 2%, or to about 1%, by weight of the composition, of an alkalizing agent, preferably sodium hydroxide. An alkalizing agent that provides buffering capacity to the composition may be particularly useful in helping to stabilize the sulfated surfactant.

The detergent compositions described herein may comprise from about 1% to about 20%, or from about 1% to about 12%, or from about 1% to about 10% by weight the composition, of one or more solvents. Liquid detergent compositions and other forms of detergent compositions that include a liquid component (such as liquid-containing unit dose detergent compositions) may contain one or more solvents and water.

Suitable solvents include lipophilic fluids, including siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, and mixtures thereof. Low molecular weight primary or secondary alcohols exemplified by methanol, ethanol, propanol, and isopropanol are also suitable. Monohydric alcohols may be used in some examples for solubilizing surfactants, and polyols such as those containing from 2 to about 6 carbon atoms and from 2 to about 6 hydroxy groups (e.g., ethylene glycol, glycerine, and 1,2-propanediol) may also be used.

Suitable solvents include ethanol, diethylene glycol (DEG), 2-methyl-1,3-propanediol (MPD), dipropylene glycol (DPG), oligamines (e.g., diethylenetriamine (DETA), tetraethylenepentamine (TEPA)), glycerine, propoxylated glycerine, ethoxylated glycerine, ethanol, 1,2-propanediol (also referred to as propylene glycol), diethylene glycol, dipropylene glycol, 1,3-propanediol, 2,3-butanediol, cellulosic ethanol, renewable propylene glycol, renewable dipropylene glycol, renewable 1,3-propanediol, other solvents used in detergent formulations, and mixtures thereof.

The detergent compositions described herein may comprise from about 1% to about 20% by weight of a solvent comprising 1,2-propanediol, renewable 1,2-propanediol, 1,3-propanediol, renewable 1,3-propanediol, ethanol, cellulosic ethanol, or mixtures thereof. The detergent compositions described herein may comprise from about 1% to about 18% by weight of a solvent comprising 1,2-propanediol, renewable 1,2-propanediol, ethanol, cellulosic ethanol, or mixtures thereof. The detergent compositions described herein may comprise from about 2% to about 16% by weight, such as, for example, 3%, 4%, 5%, 6%, 7%, 8%, 9%, 10%, 11%, 12%, 13%, 14%, or 15% of a solvent comprising 1,2-propanediol, renewable 1,2-propanediol, ethanol, cellulosic ethanol, or mixtures thereof.

Biobased propylene glycol is described in U.S. Pat. No. 7,928,148 and available from ADM. Biobased 1,3-propanediol is described in U.S. Pat. No. 8,436,046 and available from DuPont Tate & Lyle Bio Products Company, LLC.

Biobased propylene glycol may be made by catalytic hydrogenolysis (hydro cracking) of polyol. Catalytic hydrogenolysis is a process whereby polyols such as sugars, glycerol, and/or glycols are reacted with hydrogen to produce other polyols. The polyols so produced often comprise a mixture of several polyols having a lower average molecular weight than the starting material. The conversion of polyols, such as sugars and glycerol, to polyhydric alcohols, such as propylene glycol and ethylene glycol, by hydrogenolysis or by hydrocracking results in the formation of not only these alcohols, but several other products, such as 1,2-butanediol, 1,3-butanediol, 1,4-butanediol, 2,3-butanediol and 2,4-pentanediol. These products are recovered as impurities with the propylene glycol and ethylene glycol. For example, in hydrocracking of higher carbohydrates, such as sorbitol, to produce propylene glycol, typically 3-5% by weight of 2,3-butanediol is produced in addition to 1,2-butanediol, ethylene glycol, and 1,3-butanediol. U.S. Pat. No. 7,928,148 (citing U.S. Pat. No. 4,935,102) discloses a list of polyols that are produced by hydrocracking of sorbitol (Table 2):

TABLE 2
Polyols produced by Hydrocracking of
Sorbitol (U.S. Pat. No. 4,935,102)

| | Weight | Boiling Point, |
|---|---|---|
| Compound | Percent | C. |
| 23-Butanediol | 3.5 | 182 |
| Propylene glycol | 16.5 | 187 |
| 1,2-Butanediol | 2.0 | 192 |
| Ethylene glycol | 25.2 | 198 |
| 1,3-Butanediol | 3.7 | 206 |
| 2,3-Hexandiol | . . . | 206 |
| 1,2-Pentanediol | . . . | 210 |
| 1,4-Pentanediol | . . . | 220 |
| 1,4-Butanediol | 2.1 | 230 |
| 1,5-Pentanediol | 0.1 | 242 |
| Diethylene glycol | 2.2 | 248 |
| 1,6-Hexandiol | . . . | 250 |
| Triethylene glycol | 2.1 | 285 |

The detergent composition described herein may comprise from about 0.01% to about 0.1% of polyhydric alcohol. The detergent compositions described herein may comprise a polyhydric alcohol selected from the group consisting of 2,3-butanediol, 2,3-pentanediol, 2,4-pentanediol, 1,2-butanediol, 2,3-hexandiol, 1,5-pentanediol, and mixtures thereof, The detergent compositions described herein may comprise from about 0.01% to about 0.1% of 2,3-hexandiol.

In some aspects, the composition comprises water and is substantially free of organic solvent. In other aspects, the composition may comprise organic solvent. Preferred organic solvents include 1,2-propanediol, methanol, ethanol, glycerol, dipropylene glycol, diethylene glycol (DEG), methyl propane diol, and mixtures thereof. Other lower alcohols, such C1-C4 alkanolamines, e.g. monoethanolamine and/or triethanolamine, can also be used.

In some aspects, the compositions comprise from about 0.05% to about 25%, or from about 0.1% to about 15%, or from about 1% to about 10%, or from about 2% to about 5%, by weight of the composition, organic solvent. In some aspects, the composition comprises less than 5% or less than 1% of organic solvent.

The compositions of the present disclosure are acidic and have a pH less than about 7, when measured in a neat solution of the composition at 20±2° C. In some aspects, the pH of the composition is from about 2 to about 6.9, or from about 2 to about 6, or from about 2 to about 5, or from about 2.1 to about 4, or from about 2 to about 3, or from about 2.4 to about 3.

In some aspects, an alkalizing agent is added to the composition in order to obtain the desirable neat pH of the composition. However, even when the composition comprises an alkalizing agent, an acidic pH must be maintained in the final product.

Unless otherwise stated herein, the pH of the composition is defined as the neat pH of the composition at 20±2° C. Any meter capable of measuring pH to ±0.01 pH units is suitable. Orion meters (Thermo Scientific, Clintinpark-Keppekouter, Ninovesteenweg 198, 9320 Erembodegem-Aalst, Belgium) or equivalent are acceptable instruments. The pH meter should be equipped with a suitable glass electrode with calomel or silver/silver chloride reference. An example includes Mettler DB 115. The electrode should be stored in the manufacturer's recommended electrolyte solution. The pH is measured according to the standard procedure of the pH meter manufacturer. Furthermore, the manufacturer's instructions to set up and calibrate the pH assembly should be followed.

In some aspects, the detergent compositions of the present invention have a reserve acidity to a pH of 4.00 of at least about 1, or at least about 3, or at least about 5. In some aspects, the compositions herein have a reserve acidity to a pH of 4.00 of from about 3 to about 10, or from about 4 to about 7. As used herein, “reserve acidity” refers to the grams of NaOH per 100 g of product required to attain a pH of 4.00. The reserve acidity measurement as used herein is based upon titration (at standard temperature and pressure) of a 1% product solution in distilled water to an end point of pH 4.00, using standardized NaOH solution. Without being limited by theory, the reserve acidity measurement is found to be the best measure of the acidifying power of a composition, or the ability of a composition to provide a target acidic wash pH when added at high dilution into tap water as opposed to pure or distilled water. The reserve acidity is controlled by the level of formulated organic acid along with the neat product pH as well as, in some aspects, other buffers, such as alkalizing agents, for example, alkanolamines.

The detergent compositions herein may be in the form of gels or liquids, including heavy duty liquid (HDL) laundry detergents. In some aspects, the compositions have a viscosity less than about 200 cps measured at 20 s⁻¹ at 21.1° C. In some aspects, the compositions have viscosities of from about 30 cps to about 500 cps, or from about 50 cps to about 150 cps, or from about 50 cps to about 100 cps.

As used herein, unless specifically indicated to the contrary, all stated viscosities are those measured at a shear rate of 20 s⁻¹ at a temperature of 21.1° C. Viscosity herein can be measured with any suitable viscosity-measuring instrument, e.g., a Carrimed CSL2 Rheometer.

The compositions of the present invention may comprise one or more laundry adjuncts, such as builders, enzymes, stabilizers, perfumes, suds-supressors, soil-suspension polymers, soil release polymers, dye-transfer inhibitors, halide salt, and/or other benefit agents. In some aspects, the compositions comprise from about 0.01% to about 50% of a laundry adjunct. In addition to the disclosure below, further description of suitable adjuncts can be found in US Patent Application 20130072415A1, incorporated herein by reference.

The detergent compositions may comprise a builder. Suitable builders herein can be selected from the group consisting of phosphates and polyphosphates, especially the sodium salts; aluminosilicates and silicates; carbonates, bicarbonates, sesquicarbonates and carbonate minerals other than sodium carbonate or sesquicarbonate; organic mono-, di-, tri-, and tetracarboxylates especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing detergent compositions.

In some aspects, the composition comprises from about 0.00001% to about 0.01% active enzymes that are stable and effective in a low-pH environment. Suitable enzymes may include proteases, lipases, and carbohydrases, including amylases and cellulases.

The compositions may comprise perfume, such as, for example, the compositions may comprise between 0.1% by weight to 5% by weight of perfume, such as, for example, 0.5%, 1%, 1.5%, 2%, 2.5%, 3% by weight of perfume. The perfume may be an acid-stable perfume.

The perfume may be derived or may comprise an essential oil. Essential oils include and are not limited to Thyme, lemongrass, citrus, lemon, orange, anise, clove, aniseed, cinnamon, geranium, roses, mint, lavender, citronella, eucalyptus, peppermint, camphor, sandalwood and cedar. Actives of essential oils include and are not limited to thymol, eugenol, menthol, geraniol, verbenone, eucalyptol and pinocarvone, cedrol, anethol, carvacrol, hinokitiol, berberine, terpineol, limonene.

In some aspects, the compositions disclosed herein may comprise a perfume delivery system. Suitable perfume delivery systems, methods of making certain perfume delivery systems, and the uses of such perfume delivery systems are disclosed in USPA 2007/0275866 A1. Such perfume delivery system may be a perfume microcapsule. The perfume microcapsule may comprise a core that comprises perfume and a shell, with the shell encapsulating the core. The shell may comprise a material selected from the group consisting of aminoplast copolymer, an acrylic, an acrylate, and mixtures thereof. The aminoplast copolymer may be melamine-formaldehyde, urea-formaldehyde, cross-linked melamine formaldehyde, or mixtures thereof. The perfume microcapsule's shell may be coated with one or more materials, such as a polymer, that aids in the deposition and/or retention of the perfume microcapsule on the site that is treated with the composition disclosed herein. The polymer may be a cationic polymer selected from the group consisting of polysaccharides, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, poly vinyl amine, copolymers of poly vinyl amine and N-vinyl formamide, and mixtures thereof. The perfume microcapsule may be friable and/or have a mean particle size of from about 10 microns to about 500 microns or from about 20 microns to about 200 microns. In some aspects, the composition comprises, based on total composition weight, from about 0.01% to about 80%, or from about 0.1% to about 50%, or from about 1.0% to about 25%, or from about 1.0% to about 10% of perfume microcapsules. Suitable capsules may be obtained from Appleton Papers Inc., of Appleton, Wis. USA. Formaldehyde scavengers may also be used in or with such perfume microcapsules.

In some aspects, the compositions are essentially free of suds suppressor. In some aspects, the compositions comprise less than or equal to about 0.02% suds suppressor. Examples of suds suppressors useful herein include silica/silicone type, silicone oil, branched alcohols, or mixtures thereof. In some aspects, the composition comprises from about 0.05% about 1%, or from about 0.1% to about 0.4% suds supressors.

The compositions of the present disclosure may contain a soil suspension polymer; as described above, some polyamine soil suspension polymers may contribute to chemical stability of the composition or suds benefits in addition to offering cleaning benefits. In some aspects, the soil suspension polymer is selected from PEI ethoxylates, HMDA diquaternized ethoxylates, sulfonated derivatives thereof, hydrophobically modified anionic copolymers, amphiphilic graft polymers, or mixtures thereof. Examples of hydrophobically modified anionic copolymers useful herein include Acusol 480 ®, commercially available from Rohm and Haas and Alcosperse® 725 and 747 and Alcogum L520, commercially available from Alco Chemical. Suitable polymers are described in, for example, U.S. Pat. No. 7,951,768, incorporated herein by reference.

The compositions of the present disclosure may contain a soil release polymer. In one aspect, the soil release polymer is a PET alkoxylate short block copolymer, anionic derivatives thereof, or mixtures thereof.

The compositions of the present disclosure may contain dye transfer inhibitors and/or dye fixatives. Examples of dye transfer inhibitors useful herein include polyvinylpyrrolidone, poly-4-vinylpyridine-N-oxide, copolymers of N-vinyl-2-pyrrolidone and N-vinylimidazole, or mixtures thereof. Useful dye fixatives are disclosed in U.S. Pat. No. 6,753,307.

Inorganic Salt The composition may comprise inorganic salt. It has been found that inorganic salt may provide stability benefit to sulfated surfactant compositions. Certain inorganic salts may also help to build viscosity. The inorganic salt may comprise an alkali metal, an alkali earth metal, ammonium, or mixtures thereof. In some aspects, the inorganic salt comprises sodium, potassium, magnesium, calcium, ammonium, or mixtures thereof. The inorganic salt may comprise a halide, a sulfate, a carbonate, a bicarbonate, a phosphate, a nitrate, or mixtures thereof. In some aspects, the inorganic salt is sodium chloride, magnesium chloride, calcium chloride, sodium sulfate, magnesium sulfate, calcium sulfate, or mixtures thereof; in some aspects, the inorganic salt is sodium chloride, sodium sulfate, or mixtures thereof. The composition may comprise from about 0.1%, or from about 0.5%, to about 5%, or to about 3%, or to about 2%, or to about 1%, by weight of the composition, of inorganic salt.

Table 3 below shows examples of formulations encompassing the disclosed invention. The formulations are for illustrative purposes and are not meant to be prescriptive.

TABLE 3

| | Exam- | Exam- | Exam- | Exam- | Exam- | Exam- |
|---|---|---|---|---|---|---|
| MATERIALS | ple 1 | ple 2 | ple 3 | ple 4 | ple 5 | ple 6 |
| C11.8 HLAS | 6.8 | 6.8 | 6.8 | 13.8 | 6.8 | 13.8 |
| NI C24-EO9 | 10.8 | 10.8 | 10.8 | 6.2 | 10.8 | 6.2 |
| C12/14 Amine | 0.0 | 1.0 | 1.0 | 0.0 | 1.0 | 0 |
| Oxide | | | | | | |
| Citric Acid | 14.0 | 14.0 | 14.0 | 14.0 | 8.0 | 10.0 |
| Sodium | 1.0 | 1.3 | 3.2 | 2.4 | 1.0 | 2.2 |
| Hydroxide | | | | | | |
| Acetic Acid | 0.1 | 0.1 | 0.1 | 0.1 | 0.1 | 0.1 |
| Biobased | 3.0 | 10.0 | 12.76 | 15.0 | 10.0 | 15.0 |
| propylene | | | | | | |
| glycol | | | | | | |
| Perfume | 1.0 | 1.0 | 1.0 | 1.0 | 1.0 | 1.0 |
| DI Water | Balance | Balance | Balance | Balance | Balance | Balance |
| Neat pH | 2.5 | 2.5 | 3.5 | 2.5 | 2.5 | 2.5 |

The examples shown in Table 3 all have a biobased composition level greater than 50% according to ASTM D6866. Applicants have found that one can create a low pH, greater than 50% biobased formulation that does not exhibit any negative consumer effects in terms of stain removal and brightness when compared with traditional formulations. Without being bound by theory, it is believed that by balancing the ratio of HLAS to NI while having a high level of free acidity, one can create a formulation that works surprisingly well on grass stains, tea stains, coffee stains, and red wine stains. Additionally, as previously disclosed, by selectively choosing the material sources, one can create a biobased formulation that performs equal or better than a traditional non-biobased formulation on grass stains, tea stains, coffee stains, and red wine stains. Specifically, a formulation capable of exhibiting a grass stains SRI of 35 to 60, and/or a tea stain SRI of 35 to 60, and/or a coffee stain SRI of 35 to 55, and/or a red wine SRI of 30 to 50. Additionally, by selectively choosing materials, one can create a formulation that is both low pH while capable of removing food grease stains, such as burnt butter capable of exhibiting a SRI of 30 to 60, and/or a cooked beef SRI of 25 to 40, and/or a blue dyed bacon SRI of 40 to 60.

Comparative Stain Removal

Comparative Stain Removal in Liquid Laundry Detergent Compositions

| Composition | Ingredients |
|---|---|
| Tide Pure | Water, sodium laureth (1) sulfate, biobased propylene |
| Clean | glycol, nonionic surfactant C24-9, citric acid, amine |
| | oxide, sodium hydroxide, fatty acid, ethanol, poly- |
| | ethyleneimine alkoxylates, borax, DTPA, fragrance, |
| | calcium formate, sodium formate, sorbitol, protease, |
| | amylase, silicone process aid, preservative. |
| Sadlowski | Water, LAS, nonionic surfactant, citric acid, polymer, |
| U.S. Pat. No. | ethanolamine, DTPA, Tinopal CBS X, propanediol, dye, |
| 8,729,007 | perfume |
| Example 2 | HLAS, Nonionic surfactant, amine oxide, citric acid, |
| | sodium hydroxide, acetic acid, biobased propylene |
| | glycol, perfume, deionized water. |

Technical stain swatches of CW120 cotton containing grass, Lipton tea, Nescafe coffee, burnt butter, cooked beef, dyed blue bacon, and red wine, may be purchased from Accurate Product Development (Fairfield, Ohio). The swatches can be washed in a Whirlpool® front loader washing machine, using 7 grains per gallon water hardness and washed at 100 degrees Fahrenheit. The total amount of liquid detergent used in the test was 49 grams.

Standard colorimetric measurement is used to obtain L*, a* and b* values for each stain before and after the washing. From L*, a* and b* values, the stain level is calculated.

Stain removal from the swatches was measured as follows:

$$\begin{matrix}Stain Removal Index ( SRI ) = \frac{Δ {E}_{initial} - Δ {E}_{washed}}{Δ {E}_{initial}} \times 100 \\ Δ {E}_{initial} = Stain level before washing \\ Δ {E}_{washed} = Stain level after washing\end{matrix}$$

Eight replicates of each stain type should be prepared. The SRI values shown below are the averaged SRI values for each stain type. The stain level of the fabric before the washing (ΔEᵢₙᵢₜᵢₐₗ) is high; in the washing process, stains are removed and the stain level after washing is reduced (ΔE_{washed}). The better a stain has been removed, the lesser the value for AEwashed and the greater the difference between ΔEᵢₙᵢₜᵢₐₗ and ΔE_{washed} (ΔEᵢₙᵢₜᵢₐₗ−ΔE_{washed}). Therefore the value of the stain removal index increases with better washing performance

TABLE 4
SRI data

| | | | Sadlowski | | | |
|---|---|---|---|---|---|---|
| | Disclosed | | US8,729,007 | | | |
| | Formulation | | Invention | | Tide Pure | |
| | Example 2 | | formula “M” | | Clean | |
| Stain | Treatment (A) | | Treatment (B) | | Treatment (C) | |
| Grass | 59.1 | (B) | 56.7 | | 69.4 | (AB) |
| Lipton Tea | 73.4 | (BC) | 38.8 | (C) | 25.9 | |
| Nescafe Coffee | 58.1 | (C) | 56.4 | | 54.2 | |
| Red Wine | 58.4 | (C) | 56.1 | (C) | 52.1 | |
| Burnt Butter | 73.6 | (B) | 61.5 | | 71.1 | (B) |
| Cooked Beef | 35.3 | | 30.9 | | 30.7 | |
| Dyed blue bacon | 51.4 | | 48.6 | | 49.0 | |

The capital letters indicate a statistically significant win vs the indicated treatment at a 95% confidence interval. Without being bound by theory, it has been surprisingly found that by maintaining low pH formulation while combining with aspects of a naturals formulation, one can create a natural based formulation that removes bleachable stains better than both known low pH and natural based products. Additionally, without being bound by theory, it has been found that by selectively choosing the surfactants and surfactant ratios, one can create a low pH natural based formulation that does not exhibit the tradeoff traditionally exemplified by low pH formulas for other stains such as burnt butter.

These results illustrate the surprising stain removal benefits of the composition(s) disclosed herein, as compared to prior taught formulations, both in-market and not in-market.

Methodology

Whiteness Real Item testing was conducted in North American Top Loader machines, employing consumer white 100% cotton t-shirts (sourced from J&R) across 3 dinge levels (Low Dinge: where WI*CIE>140, Medium Dinge: where WI*CIE>110 but <140, and Heavy Dinge: where WI*CIE<110). A total of 2 Low, 2 Medium, and 2 Heavy T-shirts are selected and cut into squares and heat pressed onto adhesive backing so as to avoid wrinkles/bending. All t-shirt adhered squares are then pre-read for WI*CIE to ensure homogeneity within a t-shirt as specified in the Measurement Method below. T-shirt squares are then pre-selected within one same t-shirt and split into each laundry treatment, to ensure that all swatches between treatments are as identical in WI*CIE as possible. These squares are then washed in the selected Laundry treatment and post-read for WI*CIE to capture the Before/After Whiteness change per swatch. These results are then averaged by Dinge Level so as to provide Whiteness Recovery grade for each specific laundry treatment.

Measurement Method on Fabrics:

As used herein and as will be familiar one of ordinary skill, the “L*a*b* color space” are three dimensional colorimetric models developed by Hunter Associates Laboratory and recommended by the Commission Internationale d'Eclairage (“CIE”) to measure the color or change in color of a dyed article. The CIE L*a*b* color space (“CIELAB”) has a scale with three-fold axes with the L axis representing the lightness of the color space (L*=0 for black, L*=100 for white), the a* axis representing color space from red to green (a*>0 for red, a*<0 for green) and the b* axis representing color space from yellow to blue (b*>0 for yellow, b*<0 for blue). Term definitions and equation derivations are available from Hunter Associates Laboratory, Inc. and from www.hunterlab.com, and are incorporated in their entirety by reference herein. The amount of dinge removal on white fabrics can be described, for example, in terms of the change in Whiteness Index (dWI) which is derived from CIE L*a*b* before and after the wash treatment of the fabric as measured via spectrophotometry (for example, via a Spectrophotomer, manufactured by Hunter Laboratories, USA) and is reported as a dWI value. As used herein, the dWI value includes the vector associated with the distance in the Whiteness Index space (derived via the CIE L*a*b* space between the initial L*a*b* value and the final L*a*b* value). An average of two dWI measures are taken per test t-shirt square, and two squares are measured per treatment in each Dinge Level.

Relatively higher dWI values correspond to a greater Whiteness recovery, indicating that relatively more dinge was removed for the fabric in question.

TABLE 4
Whiteness change in Light Dinge Real Items under
Illuminate A Lighting conditions with 3 cycles

| DINGE LEVEL/LIGHT | DELTA WHITENESS INDEX *CIE |
|---|---|
| SOURCE | ILLUMINATE A |
| Composition from Example 1 | *6.35 |
| PurClean | 5.05 |

*indicates statistically higher Whiteness at 95% confidence interval.

Packaging for the Compositions

The detergent compositions described herein can be packaged in any suitable container including those constructed from paper, cardboard, plastic materials, and any suitable laminates. The detergent compositions described herein may also be packaged as a multi-compartment detergent composition.

The present disclosure also relates to a transparent or translucent liquid laundry detergent composition in a transparent bottle, where the composition comprises from about 1% to about 20% by weight of alkyl ether sulfate of the formula R¹—(OCH₂CH₂)ₓ—O—SO₃M, where R¹ is a non-petroleum derived, linear or branched fatty alcohol consisting of even numbered carbon chain lengths of from about C₈ to about C₂₀, and where x is from about 0.5 to about 8, and where M is an alkali metal or ammonium cation; from about 1% to about 15% by weight of fatty alcohol ethoxylate of formula R² (OCH₂CH₂)_{y} OH, where R² is a non-petroleum derived, linear or branched fatty alcohol consisting of even numbered carbon chain lengths of from about C₁₀ to about C₁₈, and where y is from about 0.5 to about 15; from about 0.1% to about 5% by weight of amine oxide; from about 0.1% to about 5% of a cleaning polymer; from about 1% to about 15% by weight of a solvent comprising 1,2-propanediol; and water; where the transparent or translucent composition has about 50% transmittance or greater of light using 1 cm cuvette at wavelength of 410-800 nanometers; and where the transparent bottle has light transmittance of greater than 25% at wavelength of about 410-800 nm.

Clear bottle materials that may be used include, but are not limited to: polypropylene (PP), polyethylene (PE), polycarbonate (PC), polyamides (PA) and/or polyethylene terephthalate (PETE), polyvinylchloride (PVC); and polystyrene (PS).

The transparent bottle or container may have a transmittance of more than about 25%, or more than about 30%, or more than about 40%, or more than about 50% in the visible part of the spectrum (approx. 410-800 nm). Alternatively, absorbency of the bottle may be measured as less than about 0.6 or by having transmittance greater than about 25%, where % transmittance equals:

$$\frac{1}{{10}^{absorbancy}} \times 100 \%$$

For purposes of the disclosure, as long as one wavelength in the visible light range has greater than about 25% transmittance, it is considered to be transparent/translucent.

The container or bottle may be of any form or size suitable for storing and packaging liquids for household use. For example, the container may have any size but usually the container will have a maximal capacity of about 0.05 to about 15 L, or about 0.1 to about 5 L, or from about 0.2 to about 2.5 L. The container may be suitable for easy handling. For example, the container may have handle or a part with such dimensions to allow easy lifting or carrying the container with one hand. The container may have a means suitable for pouring a liquid detergent composition and means for reclosing the container. The pouring means may be of any size or form. The closing means may be of any form or size (e.g., to be screwed or clicked on the container to close the container). The closing means may be cap, which can be detached from the container. Alternatively, the cap may be attached to the container, whether the container is open or closed. The closing means may also be incorporated in the container.

The compositions of the present disclosure can be formulated according to conventional methods such as those described as in U.S. Pat. No. 4,990,280; U.S. 20030087791A1; U.S. 20030087790A1; U.S. 20050003983A1; U.S. 20040048764A1; U.S. Pat. Nos. 4,762,636; 6,291,412; U.S. 20050227891A1; EP 1070115A2; U.S. Pat. Nos. 5,879,584; 5,691,297; 5,574,005; 5,569,645; 5,565,422; 5,516,448; 5,489,392; and 5,486,303, all of which are incorporated herein by reference.

The detergent compositions of the present disclosure may be used to clean, treat, and/or pretreat a fabric. In some aspects, the present disclosure provides a method of treating a surface, comprising the step of contacting the surface with the detergent compositions of the present invention. Typically at least a portion of the fabric is contacted with the aforementioned detergent compositions, in neat form or diluted in a liquor, e.g., a wash liquor, and then the fabric may be optionally washed and/or rinsed. In one aspect, a fabric is optionally washed and/or rinsed, contacted with the aforementioned detergent compositions and then optionally washed and/or rinsed. In another aspect, the detergent composition is applied onto the soiled fabric and left to act on the fabric before the fabric is washed. The composition may remain in contact with the fabric until dry or for a longer period of time, or for a period of about 1 minute to about 24 hours, or about 1 minute to about 1 hour, or about 5 minutes to about 30 minutes. For purposes of the present disclosure, washing includes, but is not limited to, scrubbing, brushing, and mechanical agitation. Typically after washing and/or rinsing, the fabric is dried. The fabric may comprise most any fabric capable of being laundered or treated. The washing may take place, for example, in a conventional fabric laundering automatic washing machine or by a hand washing method. An effective amount of the detergent composition may be added to water to form aqueous laundering solutions that may comprise from about 200 to about 15,000 ppm or even from about 300 to about 7,000 pm of detergent composition.
A. An acidic laundry detergent composition comprising from about 2% to 20% by weight of the detergent of a surfactant system and greater than 10% of an organic acid; wherein the composition comprises of greater than 34% of biobased content.
B. The acidic laundry detergent composition of paragraph A, wherein the surfactant system comprises of anionic surfactant, nonionic surfactant, and combinations thereof.
C. The acidic laundry detergent composition of paragraphs A or B, wherein the surfactant system comprises amine oxide.
D. The acidic laundry detergent composition of any of the prior paragraphs A-C, wherein the composition exhibits greater than 50% transmittance.
E. The acidic laundry detergent composition of any of the prior paragraphs A-D, wherein the composition comprises from about 15% to 20% by weight of the detergent of a surfactant system.
F. The acidic laundry detergent composition of any of the prior paragraphs A-E, wherein the composition further comprises a perfume from an essential oil.
G. The acidic laundry detergent composition of any of the prior paragraphs A-F, wherein the composition comprises a reserve acidity of at least 3.
H. The acidic laundry detergent composition of any of the prior paragraphs A-G, wherein the composition comprises a neat pH between 2 and 3.
I. The acidic laundry detergent composition of any of the prior paragraphs A-H, wherein the composition comprises of no more than 10 components.
J. The acidic laundry detergent composition of any of the prior paragraphs A-I, wherein the composition comprises of between 1% and 20% of a renewable solvent.
K. The acidic laundry detergent composition of paragraph J, wherein the laundry detergent composition comprises a polyhydric alcohol selected from the group consisting of 2,3-butanediol, 2,3-pentanediol, 2,4-pentanediol, 1,2-butanediol, 2,3-hexandiol, 1,5-pentanediol, and mixtures thereof.
L. The acidic laundry detergent composition of any of the prior paragraphs A-K, wherein the composition is free of brighteners and dyes.
M. The acidic laundry detergent composition of any of the prior paragraphs A-L, wherein the composition comprises a ratio of surfactant system to organic acid of less than or equal to about 3.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. An acidic laundry detergent composition comprising from about 2% to 20% by weight of the detergent of a surfactant system and greater than 10% of an organic acid; wherein the composition comprises of at least 34% of biobased content.

2. The acidic laundry detergent composition of claim 1, wherein the surfactant system comprises of anionic surfactant, nonionic surfactant, and combinations thereof.

3. The acidic laundry detergent composition of claim 1, wherein the surfactant system comprises amine oxide.

4. The acidic laundry detergent composition of claim 1, wherein the composition exhibits greater than 50% transmittance.

5. The acidic laundry detergent composition of claim 1, wherein the composition comprises from about 15% to 20% by weight of the detergent of a surfactant system.

6. The acidic laundry detergent composition of claim 1, wherein the composition further comprises a perfume from an essential oil.

7. The acidic laundry detergent composition of claim 1, wherein the composition comprises a reserve acidity of at least 1.

8. The acidic laundry detergent composition of claim 1, wherein the composition comprises a neat pH between 2 and 3.

9. The acidic laundry detergent composition of claim 1, wherein the composition comprises of no more than 10 components.

10. The acidic laundry detergent composition of claim 1, wherein the composition comprises of between 1% and 20% of a renewable solvent.

11. The acidic laundry detergent composition of claim 10, wherein the laundry detergent composition comprises a polyhydric alcohol selected from the group consisting of 2,3-butanediol, 2,3-pentanediol, 2,4-pentanediol, 1,2-butanediol, 2,3-hexandiol, 1,5-pentanediol, and mixtures thereof.

12. The acidic laundry detergent composition of claim 1, wherein the composition is free of brighteners and dyes.

13. The acidic laundry detergent composition of claim 1, wherein the composition comprises a ratio of surfactant system to organic acid of less than or equal to about 3.

14. An acidic laundry detergent composition comprising from about 2% to 20% by weight of the detergent of a surfactant system and greater than 10% of an organic acid; wherein the composition comprises of at least 50% of biobased content.

15. The acidic laundry detergent composition of claim 14, wherein the composition comprises of between 1% and 20% of a renewable solvent.

16. The acidic laundry detergent composition of claim 15, wherein the laundry detergent composition comprises a polyhydric alcohol selected from the group consisting of 2,3-butanediol, 2,3-pentanediol, 2,4-pentanediol, 1,2-butanediol, 2,3-hexandiol, 1,5-pentanediol, and mixtures thereof.

17. The acidic laundry detergent composition of claim 14, wherein the composition comprises a reserve acidity of at least 1.

18. The acidic laundry detergent composition of claim 14, wherein the surfactant system comprises amine oxide.

19. The acidic laundry detergent composition of claim 14, wherein the composition comprises of no more than 10 components.

20. The acidic laundry detergent composition of claim 1, wherein the composition comprises a neat pH between 2 and 3.
